(19) United States
(12) Patent Application Publication
(10) Pub. No.: US 2026/0355055 A1
(43) Pub. Date: Nov. 12, 2026

(54) MULTI-ADAPTATION MASSAGE CONTROL DEVICE AND MULTI-ADAPTATION MASSAGER ASSEMBLY

(71) Applicant: Dongguan Dingfoo Plastic Products Co.,Ltd, Dongguan (CN)

(72) Inventor: QIUMING LIU, Dongguan (CN)

(21) Appl. No.: 19/236,914

(22) Filed: Jun. 12, 2025

(30) Foreign Application Priority Data
May 7, 2025 (CN) 202520880964.3

(51) Int. Cl. A61H 23/02

(52) U.S. Cl. CPC A61H 23/0218; A61H 23/0263; A61H 2201/0107; A61H 2201/0192; A61H 2201/1671; A61H 2201/5002; A61H 2201/503; A61H 2201/5046; A61H 2201/5048

(57) ABSTRACT

The present disclosure relates to a multi-adaptation massage control device and a multi-adaptation massager assembly. The multi-adaptation massager assembly includes the multi-adaptation massage control device and a plurality of massagers. The multi-adaptation massage control device includes: a control unit, a power supply unit, a first interface unit, a first housing, and a control button. The multi-adaptation massager assembly includes the multi-adaptation massage control device and the massager assembly, in which the massager assembly includes the plurality of massagers, and a single multi-adaptation massage control device is adapted to interface with the plurality of massagers in the massager assembly. Each massager includes a motor, a massage module, a second interface unit, and a second housing.

### CROSS-REFERENCE TO RELATED APPLICATIONS

This application claims priority to Chinese Patent Application No. 202520880964.3, filed on May 07, 2025, which is hereby incorporated by reference in its entirety.

### TECHNICAL FIELD

The present disclosure relates to a massage control device and a massager assembly, and more particularly to a multi-adaptation massage control device and a multi-adaptation massager assembly.

### BACKGROUND

In the prior art, the increasing variety and functional complexity of massagers has created scenarios where a single user may require multiple massagers to perform diverse operations. The controller, which includes high-value components such as printed circuit board assemblies (PCBAs) and control chips, constitutes the most costly portion of a massager. When a user purchases multiple massagers with different functionalities, the redundant controllers result in prohibitively high costs, thereby limiting practical utility.

### SUMMARY

To construct a multi-adaptation massage control device and massager assembly that resolves the prior art issue of excessive costs when using multiple functionally distinct massagers.

The technical solution of the present disclosure is a multi-adaptation massage control device, including:
a control unit including a printed circuit board assembly, PCBA, and a controller disposed on the PCBA, the controller being configured to control operation of a motor in a massager;
a power supply unit including a battery and a charging interface, the power supply unit being configured to supply electrical energy to the control unit and the motor in the massager;
a first interface unit including a first electrical connection module, connected to the control unit and the power supply unit, and when in use, electrically connected to an external massager to connect the controller in the control unit and the power supply unit to the motor in the massager;
a first housing housing the control unit and the power supply unit, the first interface unit being disposed on the first housing; and
a control button disposed on the first housing and connected to the control unit, the control button being configured to input control information.

The technical solution of the present disclosure is a multi-adaptation massager assembly, including:
a multi-adaptation massage control device including:
a control unit including a printed circuit board assembly, PCBA, and a controller disposed on the PCBA, the controller being configured to control operation of a motor in a massager;
a power supply unit including a battery and a charging interface, the power supply unit being configured to supply electrical energy to the control unit and the motor in the massager;
a first interface unit including a first electrical connection module, connected to the control unit and the power supply unit, and when in use, electrically connected to an external massager to connect the controller in the control unit and the power supply unit to the motor in the massager;
a first housing receiving the control unit and the power supply unit, the first interface unit being partially disposed on the first housing; and
a control button disposed on the first housing and connected to the control unit, the control button being configured to input control information;

the massager assembly includes a plurality of massagers, in which the multi-adaptation massage control device is adapted to interface with the plurality of massagers, each massager including:
a motor including at least one of an eccentric motor or a vibration motor;
a massage module connected to the motor and driven thereby;
a second interface unit configured to mate with the first interface unit, the second interface unit connecting the motor to the first interface unit; and
a second housing receiving the motor and the massage module, the second interface unit being disposed on the second housing.

The present disclosure achieves the technical effects of constructing a multi-adaptation massage control device and a multi-adaptation massager assembly. The multi-adaptation massager assembly includes the multi-adaptation massage control device and a plurality of massagers forming a massager assembly. The multi-adaptation massage control device includes: a control unit including a printed circuit board assembly, PCBA, and a controller disposed on the PCBA, the controller being configured to control operation of a motor in a massager; a power supply unit including a battery and a charging interface, the power supply unit being configured to supply electrical energy to the control unit and the motor in the massager; a first interface unit including a first electrical connection module, connected to the control unit and the power supply unit, and when in use, electrically connected to an external massager to connect the controller in the control unit and the power supply unit to the motor in the massager; a first housing receiving the control unit and the power supply unit, the first interface unit being partially disposed on the first housing; and a control button disposed on the first housing and connected to the control unit, the control button being configured to input control information; a plurality of massagers constituting the massager assembly, in which the multi-adaptation massage control device is adapted to interface with the plurality of massagers, each massager including: a motor including at least one of an eccentric motor or a vibration motor; a massage module connected to the motor and driven thereby; a second interface unit configured to mate with the first interface unit, the second interface unit connecting the motor to the first interface unit; and a second housing receiving the motor and the massage module, the second interface unit being disposed on the second housing. The multi-adaptation massage control device and multi-adaptation massager assembly of the present disclosure enable a single multi-adaptation massage control device to adapt to a plurality of massagers by forming a connection through the first interface unit and the second interface unit, such that only one massage control device is required to be applicable to multiple types of massagers, thereby significantly reducing costs.

### BRIEF DESCRIPTION OF THE DRAWINGS

FIG. 1 is a schematic structural diagram of the multi-adaptation massage control device of the present disclosure.

FIG. 2 is a schematic structural diagram of the multi-adaptation massager of the present disclosure.

FIG. 3 is a schematic diagram showing the combination of the multi-adaptation massage control device with a massager according to the present disclosure.

### DETAILED DESCRIPTION

Detailed embodiments of the technical solutions of the present disclosure are further described below with reference to specific examples.

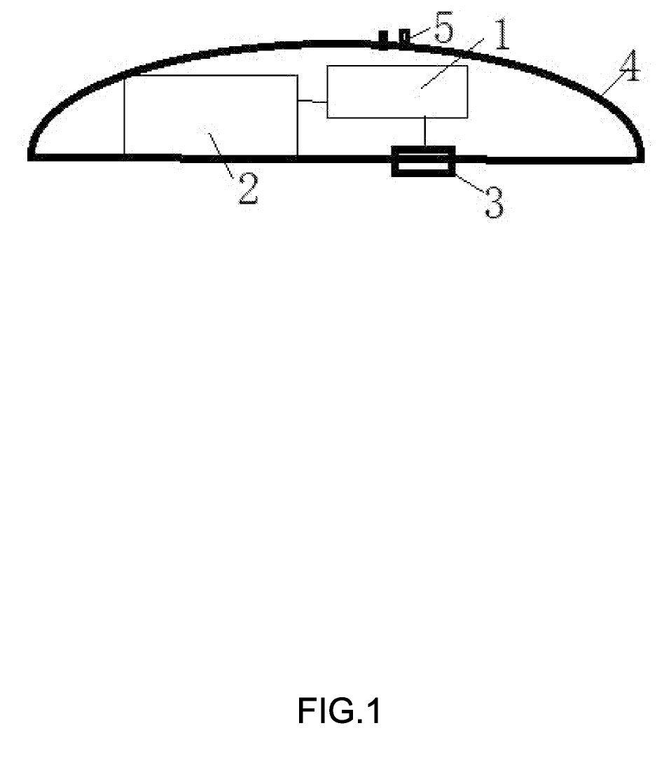

As shown in FIG. 1, a specific embodiment of the present disclosure is constructed as follows: A multi-adaptation massage control device includes a control unit 1, a power supply unit 2, a first interface unit 3, a first housing 4, and a control button 5. The control unit 1 includes a printed circuit board assembly, PCBA, and a controller disposed on the PCBA, the controller being configured to control operation of a motor in a massager. The controller includes a control chip. The controller is further configured to control operation of the motor in the massager, regulate the power supply unit 2, or operate at least one auxiliary module, such as a display module, a communication module, an audio output module, a voice input module, and a voice recognition module. The power supply unit 2 includes a battery and a charging interface. The battery is a rechargeable battery. The charging interface is configured to charge the rechargeable battery. The power supply unit 2 is configured to supply electrical energy to the control unit and to supply electrical energy to the motor 6 in the massager through the first interface unit 3 and a second interface unit 8. The first interface unit 3 includes a first electrical connection module. The first interface unit 3 is connected to the control unit 1 and the power supply unit 2. During use, the first interface unit 3 is electrically connected to an external massager to connect the controller in the control unit 1 and the power supply unit 2 to the motor in the massager. The first housing 4 houses the control unit 1 and the power supply unit 2. The first interface unit 3 is disposed on the first housing 4. A portion of the first interface unit 3 is disposed inside the first housing 4. Another portion of the first interface unit 3 is exposed outside the first housing 4. The control button 5 is disposed on the first housing 4 and connected to the control unit 1. The control button 5 inputs control information through button operations. The control button 5 may be a physical mechanical button or a touch-sensitive button.

As shown in FIG. 1, a specific implementation process of the present disclosure is as follows. The first housing 4 receives the control unit 1 and the power supply unit 2. The first interface unit 3 is disposed on the first housing 4. A portion of the first interface unit 3 is disposed inside the first housing 4. Another portion of the first interface unit 3 is exposed outside the first housing 4. The controller of the control unit 1 is disposed on the PCBA. The control unit 1 controls operation of the motor in the massager through the first interface unit 3 and a second interface unit 8. The power supply unit 2 is configured to supply electrical energy to the control unit and to supply electrical energy to the motor 6 in the massager through the first interface unit 3 and a second interface unit 8. The control button 5 inputs control information through button operations. The control unit 1 then controls operation of the motor in the massager through the first interface unit 3 and a second interface unit 8. The multi-adaptation massage control device can be adapted to a plurality of different massagers. This significantly reduces costs and enriches usage scenarios of the massagers.

As shown in FIG. 1, an embodiment of the present disclosure is as follows. The first electrical connection module is a plug-in electrical connection module. The plug-in electrical connection module forms a plug-in electrical connection mode by arranging electrical connection pins that engage with electrical connection slots in the second interface unit. The first electrical connection module may alternatively be a magnetically-attachable electrical connection module. The magnetically-attachable electrical connection module includes a magnetic attachment assembly and an electrical contact assembly. The magnetic attachment assembly brings the magnetically-attachable electrical connection module into proximity with the second interface unit. The electrical contact assembly is thereby pressed against corresponding portions of the second interface unit to establish electrical connection.

As shown in FIG. 1, another embodiment of the present disclosure is as follows. The control button 5 includes at least one of a mechanical control button or a touch-sensitive control button. The control button 5 may be a physical mechanical button or a touch-sensitive button.

As shown in FIG. 1, an embodiment of the present disclosure is as follows. The multi-adaptation massage control device further includes at least one of a display module, a communication module, an audio output module, a voice input module, and a voice recognition module. The display module is configured to display usage modes, operational parameters, power status, and runtime data of the massager. The communication module is a wireless communication module. The communication module establishes a communication link with external devices. The external devices operate the multi-adaptation massage control device through the communication module to control the massager. The audio output module is configured to output audio. When audio files are stored in the multi-adaptation massage control device, the audio output module plays the stored audio files. Alternatively, the multi-adaptation massage control device connects to external devices through the communication module, enabling the external devices to output audio through the audio output module. The voice input module is a microphone. The voice recognition module processes voice data. The voice input module and voice recognition module collectively enable voice information input. The system can output voice feedback or execute voice commands to operate the multi-adaptation massage control device.

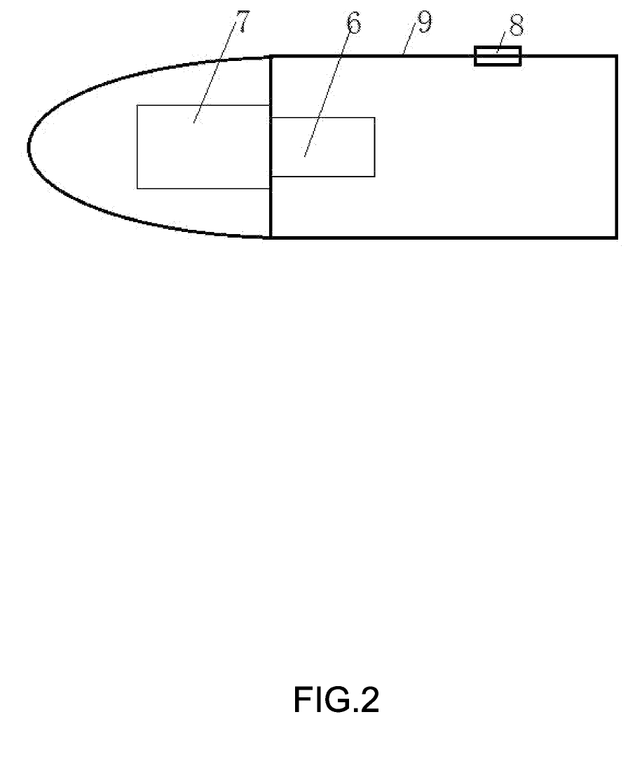

As shown in FIG. 2, a specific implementation of the present disclosure is as follows. A multi-adaptation massager assembly is constructed, including a multi-adaptation massage control device and a massager assembly. The massager assembly is formed by a plurality of massagers. A single multi-adaptation massage control device is adapted to interface with the plurality of massagers in the massager assembly.

The multi-adaptation massage control device includes a control unit 1, a power supply unit 2, a first interface unit 3, a first housing 4, and a control button 5. The control unit 1 includes a printed circuit board assembly, PCBA, and a controller disposed on the PCBA, the controller being configured to control operation of a motor in a massager. The controller includes a control chip. The controller is further configured to control operation of the motor in the massager, any may regulate the power supply unit 2, or operate at least one auxiliary module, such as a display module, a communication module, an audio output module, a voice input module, and a voice recognition module. The power supply unit 2 includes a battery and a charging interface. The battery is a rechargeable battery. The charging interface is configured to charge the rechargeable battery. The power supply unit 2 is configured to supply electrical energy to the control unit and to supply electrical energy to the motor 6 in the massager through the first interface unit 3 and a second interface unit 8. The first interface unit 3 includes a first electrical connection module. The first interface unit 3 is connected to the control unit 1 and the power supply unit 2. During use, the first interface unit 3 is electrically connected to an external massager to connect the controller in the control unit 1 and the power supply unit 2 to the motor in the massager. The first housing 4 houses the control unit 1 and the power supply unit 2. The first interface unit 3 is disposed on the first housing 4. A portion of the first interface unit 3 is disposed inside the first housing 4. Another portion of the first interface unit 3 is exposed outside the first housing 4. The control button 5 is disposed on the first housing 4 and connected to the control unit 1. The control button 5 inputs control information through button operations. The control button 5 may be a physical mechanical button or a touch-sensitive button. Each massager includes a motor 6, a massage module 7, a second interface unit 8, and a second housing 9. The motor 6 drives operation of the massage module 7. The motor 6 includes at least one of an eccentric motor or a vibration motor. The massage module 7 is connected to the motor 6. The motor 6 drives operation of the massage module 7. The second interface unit 8 is configured to mate with the first interface unit 3. The second interface unit 8 connects the motor 6 to the first interface unit 3. The second housing 9 receives the motor 6 and the massage module 7. The second interface unit 8 is disposed on the second housing 9.

As shown in FIGS. 1 and 2, a specific implementation process of the present disclosure is as follows. The multi-adaptation massage control device includes a control unit 1, a power supply unit 2, a first interface unit 3, a first housing 4, and a control button 5. The first housing 4 houses the control unit 1 and the power supply unit 2. The first interface unit 3 is disposed on the first housing 4. A portion of the first interface unit 3 is disposed inside the first housing 4. Another portion of the first interface unit 3 is exposed outside the first housing 4. The controller of the control unit 1 is disposed on the PCBA. The control unit 1 controls operation of the motor in the massager through the first interface unit 3 and a second interface unit 8. The power supply unit 2 is configured to supply electrical energy to the control unit and to supply electrical energy to the motor 6 in the massager through the first interface unit 3 and a second interface unit 8. The control button 5 inputs control information through button operations. The control unit 1 then controls operation of the motor in the massager through the first interface unit 3 and a second interface unit 8. The multi-adaptation massager assembly includes the multi-adaptation massage control device and a massager assembly. The massager assembly is formed by a plurality of massagers. A single multi-adaptation massage control device is adapted to interface with the plurality of massagers in the massager assembly. Each massager includes a motor 6, a massage module 7, a second interface unit 8, and a second housing 9. The motor 6 drives operation of the massage module 7. The second interface unit 8 is configured to mate with the first interface unit 3. The second interface unit 8 connects the motor 6 to the first interface unit 3. The second housing 9 receives the motor 6 and the massage module 7. The second interface unit 8 is disposed on the second housing 9.

As shown in FIG. 2, an embodiment of the present disclosure is as follows. The massage module 7 includes at least one of a vibration module, a rotation module, an extension-retraction module, an adsorption module, and an electromagnetic pulse module. The vibration module is driven by the motor 6 to generate vibrations. The vibrations drive the massage module 7 to vibrate. The extension-retraction module is driven by the motor 6 to produce linear reciprocating motion. The reciprocating motion drives the massage module 7 to extend and retract. The adsorption module is driven by the motor 6 to create surface undulations. The adsorption module is disposed on the second housing 9. A surface of the adsorption module is formed of flexible material. The surface generates suction forces through the undulations. The electromagnetic pulse module generates electromagnetic pulses. The electromagnetic pulses generate impacts to produce vibrations.

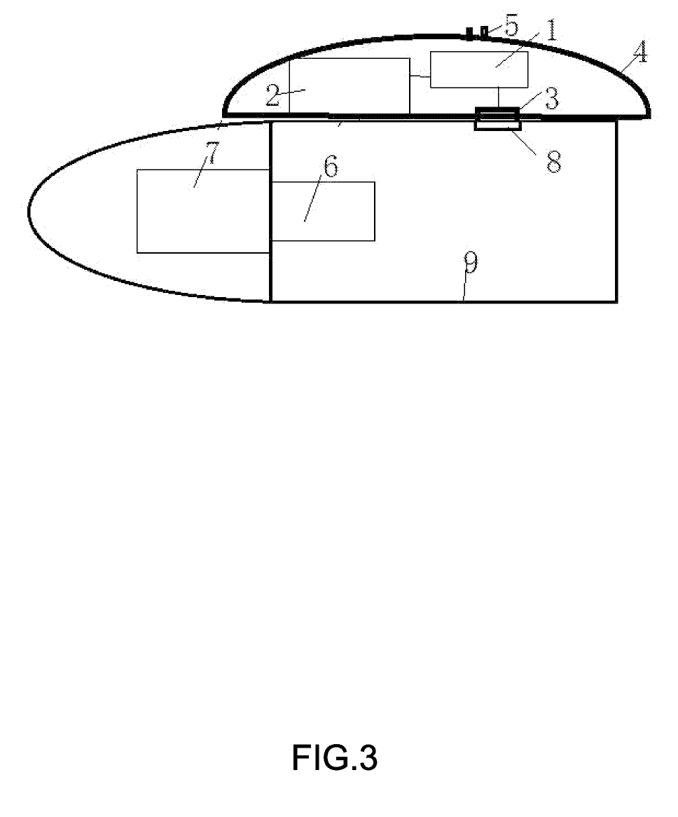

As shown in FIG. 3, another embodiment of the present disclosure is as follows. The massager defines three axial directions (X, Y, Z). The second interface unit 8 is disposed laterally on the second housing 9 along a longitudinal axis of the massager. The first interface unit 3 and the second interface unit 8 connect perpendicularly or obliquely. The connection establishes direct physical contact between the units. The first interface unit 3 and the second interface unit 8 form a plug-in connection. Alternatively, the first interface unit 3 and the second interface unit 8 form a magnetic attachment connection.

The present disclosure achieves the technical effects of constructing a multi-adaptation massage control device and a multi-adaptation massager assembly. The multi-adaptation massager assembly includes the multi-adaptation massage control device and a plurality of massagers forming the massager assembly. The multi-adaptation massage control device includes a control unit 1 including a PCBA and a controller disposed on the PCBA, the controller being configured to control operation of a motor in a massager. The controller includes a control chip. The controller is further configured to control operation of the motor in the massager, any may regulate the power supply unit 2, or operate at least one auxiliary module, such as a display module, a communication module, an audio output module, a voice input module, and a voice recognition module. The power supply unit 2 includes a battery and a charging interface. The battery is a rechargeable battery. The charging interface is configured to charge the rechargeable battery. The power supply unit 2 is configured to supply electrical energy to the control unit and to supply electrical energy to the motor 6 in the massager through the first interface unit 3 and a second interface unit 8. The first interface unit 3 includes a first electrical connection module. The first interface unit 3 is connected to the control unit 1 and the power supply unit 2. During use, the first interface unit 3 is electrically connected to an external massager to connect the controller in the control unit 1 and the power supply unit 2 to the motor in the massager. The first housing 4 houses the control unit 1 and the power supply unit 2. The first interface unit 3 is disposed on the first housing 4. A portion of the first interface unit 3 is disposed inside the first housing 4. Another portion of the first interface unit 3 is exposed outside the first housing 4. The control button 5 is disposed on the first housing 4 and connected to the control unit 1. The control button 5 inputs control information through button operations. The control button 5 may be a physical mechanical button or a touch-sensitive button. Each massager includes a motor 6, a massage module 7, a second interface unit 8, and a second housing 9. The motor 6 drives operation of the massage module 7. The motor 6 includes at least one of an eccentric motor or a vibration motor. The massage module 7 is connected to the motor 6. The motor 6 drives operation of the massage module 7. The second interface unit 8 is configured to mate with the first interface unit 3. The second interface unit 8 connects the motor 6 to the first interface unit 3. The second housing 9 receives the motor 6 and the massage module 7. The second interface unit 8 is disposed on the second housing 9. The multi-adaptation massage control device and multi-adaptation massager assembly of the present disclosure enable a single multi-adaptation massage control device to adapt to a plurality of massagers by forming a connection through the first interface unit and the second interface unit, such that only one massage control device is required to be applicable to multiple types of massagers, thereby significantly reducing costs.

In some implementations, the first electrical connection module is a plug-in electrical connection module.

In some implementations, the first electrical connection module is a magnetically-attachable electrical connection module.

In some implementations, the control button includes at least one of a mechanical control button or a touch-sensitive control button.

In some implementations, the multi-adaptation massage control device further includes at least one of a display module, a communication module, an audio output module, a voice input module, and a voice recognition module.

In some implementations, the massage module includes at least one of a vibration module, a rotation module, an extension-retraction module, an adsorption module, and an electromagnetic pulse module.

In some implementations, the second interface unit is disposed laterally on the second housing along a longitudinal axis of the massager.

In some implementations, the first interface unit and the second interface unit are connected via a plug-in connection.

In some implementations, the first interface unit and the second interface unit are connected via a magnetically-attachable connection.

The above descriptions are provided in conjunction with specific embodiments to further elaborate the present disclosure. These explanations should not be construed as limiting the scope of implementation to the disclosed details. For those skilled in the technical field of the present disclosure, simple derivations or substitutions may be made without departing from the inventive concept of the present disclosure. All such modifications shall fall within the protection scope of the present disclosure.

What is claimed is:

1. A multi-adaptation massage control device, comprising:
a control unit comprising a printed circuit board assembly, PCBA, and a controller disposed on the PCBA, the controller being configured to control operation of a motor in a massager;
a power supply unit comprising a battery and a charging interface, the power supply unit being configured to supply electrical energy to the control unit and the motor in the massager;
a first interface unit comprising a first electrical connection module, connected to the control unit and the power supply unit, and when in use, electrically connected to an external massager to connect the controller in the control unit and the power supply unit to the motor in the massager;
a first housing receiving the control unit and the power supply unit, the first interface unit being disposed on the first housing; and
a control button disposed on the first housing and connected to the control unit, the control button being configured to input control information.

2. The multi-adaptation massage control device according to claim 1, wherein the first electrical connection module is a plug-in electrical connection module.

3. The multi-adaptation massage control device according to claim 1, wherein the first electrical connection module is a magnetically-attachable electrical connection module.

4. The multi-adaptation massage control device according to claim 1, wherein the control button comprises at least one of a mechanical control button or a touch-sensitive control button.

5. The multi-adaptation massage control device according to claim 1, further comprising at least one of a display module, a communication module, an audio output module, a voice input module, and a voice recognition module.

6. A multi-adaptation massager assembly, comprising:
a multi-adaptation massage control device comprising:
a control unit comprising a printed circuit board assembly, PCBA, and a controller disposed on the PCBA, the controller being configured to control operation of a motor in a massager;
a power supply unit comprising a battery and a charging interface, the power supply unit being configured to supply electrical energy to the control unit and the motor in the massager;
a first interface unit comprising a first electrical connection module, connected to the control unit and the power supply unit, and when in use, electrically connected to an external massager to connect the controller in the control unit and the power supply unit to the motor in the massager;
a first housing receiving the control unit and the power supply unit, the first interface unit being partially disposed on the first housing; and
a control button disposed on the first housing and connected to the control unit, the control button being configured to input control information,
wherein the massager assembly comprises a plurality of massagers, and the multi-adaptation massage control device is adapted to interface with the plurality of massagers, each massager comprising:
a motor comprising at least one of an eccentric motor or a vibration motor;
a massage module connected to the motor and driven thereby;
a second interface unit configured to mate with the first interface unit, the second interface unit connecting the motor to the first interface unit; and
a second housing receiving the motor and the massage module, the second interface unit being disposed on the second housing.

7. The multi-adaptation massager assembly according to claim 6, wherein the massage module comprises at least one of a vibration module, a rotation module, an extension-retraction module, an adsorption module, and an electromagnetic pulse module.

8. The multi-adaptation massager assembly according to claim 6, wherein the second interface unit is disposed laterally on the second housing along a longitudinal axis of the massager.

9. The multi-adaptation massager assembly according to claim 6, wherein the first interface unit and the second interface unit are connected via a plug-in connection.

10. The multi-adaptation massager assembly according to claim 6, wherein the first interface unit and the second interface unit are connected via a magnetically-attachable connection.
